(19) United States
(12) Patent Application Publication
(10) Pub. No.: US 2018/0178048 A1
(43) Pub. Date: Jun. 28, 2018

(54) Automatic Chimney Fire Suppression System

(71) Applicant: Jim Polasek, Spring Branch, TX (US)

(72) Inventor: Jim Polasek, Spring Branch, TX (US)

(21) Appl. No.: 14/088,190

(22) Filed: Nov. 22, 2013

(51) Int. Cl. A62C 3/04; A62C 35/10

(52) U.S. Cl. CPC A62C 3/04; A62C 35/10

(57) ABSTRACT

A fire suspension to suppress a chimney fire may include a chimney connecting device to connect to a chimney and a rain dome to define an internal cavity. The internal cavity may include fire suppressing material. The rain dome may include a horizontal delivery door which is destructively opened in response to a chimney fire.

### FIELD OF THE INVENTION

The present invention relates to a fire suppression system and more particularly to a fire suppression system for a chimney.

### BACKGROUND

Fires in homes and other dwellings are a cause of loss of life and property damage. Chimney fires are a major contribution to the fires in homes and dwellings. These chimney fires may be caused by the buildup of combustibles within the chimneys such as creosote which may result from the burning of wood or other types of material. The chimney fires may quickly involve other areas within the house such as the roof and attic. If not quickly contain, the entire structure may be lost due to fire. The buildup of these combustibles within the chimney is a relatively slow process and may not be noticed until it is too late. Generally, the creosote is not readily visible without a detailed inspection. Periodic cleaning of the chimney may be effective in removing the combustibles from the chimney, but most users do not keep their chimneys sufficiently clean. But it would be desirable to have a system that would put out the fire should one develop.

Chimneys usually exhaust gases between 400-700 degrees, depending on size and time of fire. Chimney fires happen when the build up of material (usually creosote), ignite thus increasing the flue temperature above 1700-2100 degrees Fahrenheit.

### SUMMARY

A fire suspension to suppress a chimney fire may include a chimney connecting device to connect to a chimney and a rain dome to define an internal cavity.

The internal cavity may include fire suppressing material.

The rain dome may include a horizontal delivery door which is destructively opened in response to a chimney fire.

The fire suppressing material is B and C fire suppressing material.

The chimney connecting device may include an adjustable connecting band to connect to the chimney.

The chimney connecting device may include a horizontal grid to allow smoke and small particles to escape from the chimney.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a exploded view of the fire suppression system of the present invention;

FIG. 2 illustrates a cross-sectional view of the fire suppression system of the present invention;

FIG. 3 illustrates a top view of the fire suppression system of the present invention;

FIG. 4 illustrates a bottom view of the fire suppression system of the present invention.

### DETAILED DESCRIPTION

The present invention replaces non-fire suppressing Chimney Caps and Spark Arrestors with a fire suppressing Chimney Cap which may include an adjustable base/band 107, where the adjustable base 107 of the ACFSS (Automatic Chimney Fire Suppression System), will fit Chimney flues 117 by an adjusting band 107, that is adjusted by the tightening or loosening a screw or other fastening devices.

The chimney connecting device 121 which connects the chimney 117 to the dome 109 includes a horizontal grid 101 which may include a metal mesh for releasing the flue gases into the atmosphere. This area of the horizontal grid 101 may vary in height depending on the size of the Chimney.

The internal cavity 119 of the rain cap/dome 109 may store sufficient quantities of B and C rated fire extinguishing material 111 in order to extinguish a chimney fire. The extinguishing material 111 may be stored under the metal rain cap, in a water tight compartment, and a horizontal delivery door 105 may be positioned the bottom of the internal cavity 119. The horizontal delivery door 105 may be destructively opened in response to a fire within the chimney 117 and may be formed from metal and connected to the rain dome 109 and held in place by a brazing technique, using for example copper and silver brazing material that melts between 1100 and 1400 degrees.

The ACFSS cap/rain dome 109 holding the extinguishing material 111 will automatically release the extinguishing material 111 by the melting of the brazing material holding the horizontal delivery door 105 of the rain cap in place, thus dumping the extinguishing material 111 down the flue, overcoming the flue gases rapid force and extinguishing the “over” fire condition of the chimney.

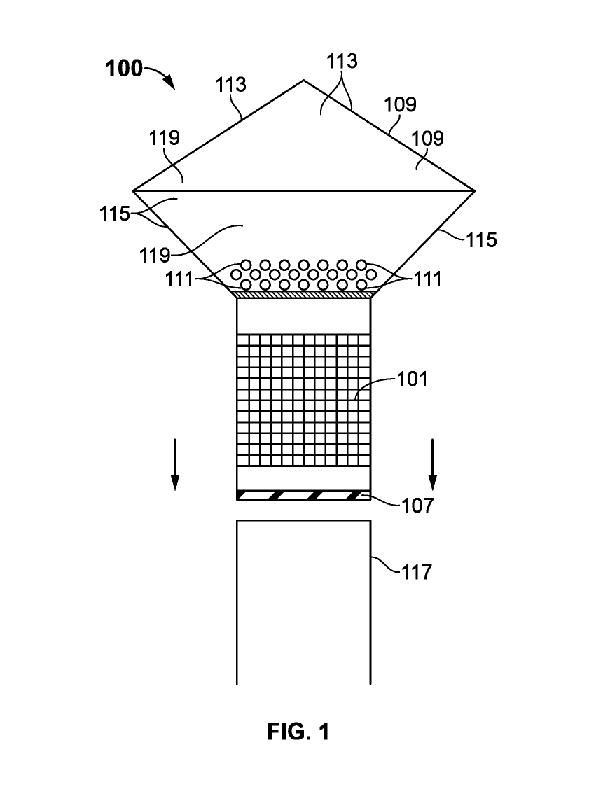

FIG. 1 illustrates an exploded view of the fire suppression system 100 of the present invention. The fire suppression system 100 may include a fire suppression device 107 which may be detachably connected to the structure chimney 117 (which may be residential or commercial). The fire suppression device 101 may include a rain dome 109 (rain cap) which may include an opposed front and back top inclined wall 113 and an opposed pair of side inclined walls 113 and which may include an opposed front and back bottom inclined walls 115 and a pair of opposed side bottom inclined walls 115. The rain dome 109 may define an internal cavity 119 to store the fire distinguishing material 111. The top back and side bottom walls may connect to a horizontal delivery door 105 which may be destructively responsive to the heat within the chimney 117. More particularly, the horizontal delivery door 105 may remain closed to maintain the fire extinguishing material 111 within the internal cavity 119 when the heat within the chimney 117 is within normal operating temperatures and may open to release the fire extinguishing material 111 from the internal cavity 119 into the chimney 117 when the temperature exceeds the normal operating temperature, indicating a fire within the chimney 117. The fire extinguishing material 111 acts to extinguish the fire within the chimney 117.

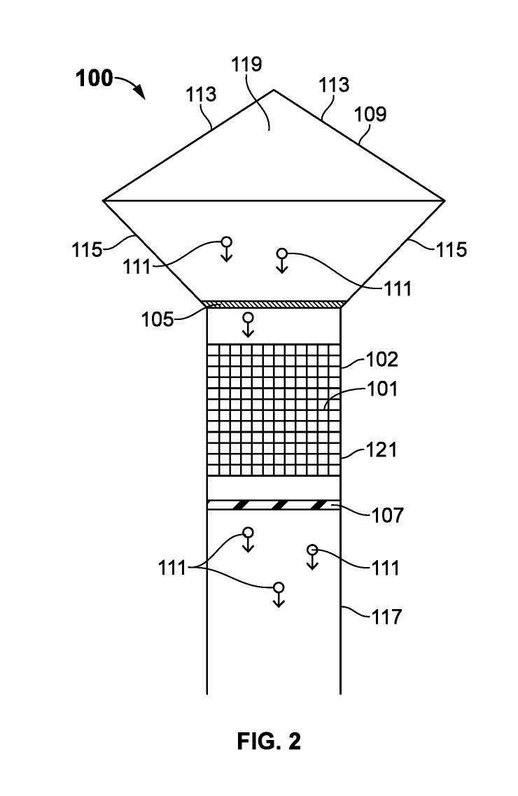

FIG. 2 illustrates the fire extinguishing material 111 being released and entering the chimney 117.

Chimney connecting device 121 connects the chimney 117 with the rain Dome 109 and may include a horizontal grid 101 (mesh screen) which may extend around the periphery of the chimney connecting device 121. The chimney connecting device 121 may have substantially the same cross-section as the chimney 117 (for example circular or rectangular) and may include an adjustable connecting band 107 which may adjust in dimension in order to detachably connect to the chimney 117 and may connect to a collar (not shown) to connect to a chimney 117 being a different size or shape. The chimney connecting device 121 includes the horizontal grid 101 to allow smoke and small particles to escape from the chimney 117.

FIG. 2 illustrates a cross-sectional view of the fire suppression system 100 of the present invention. The fire suppression system 100 may include a fire suppression device 102 which may be detachably connected to the structure chimney 117 (which may be residential or commercial). The fire suppression device 107 may include a rain dome 109 (rain cap) which may include an opposed front and back top inclined wall 113 and an opposed pair of side inclined walls 113 and which may include an opposed front and back bottom inclined walls 115 and a pair of opposed side bottom inclined walls 115. The rain dome 109 may define an internal cavity 119 to store the fire distinguishing material 111. The top back and side bottom walls may connect to a horizontal delivery door 105 which may be destructively responsive to the heat within the chimney 117. More particularly, the horizontal delivery door 105 may remain closed to maintain the fire extinguishing material 111 within the internal cavity 119 when the heat within the chimney 117 is within normal operating temperatures and may open to release the fire extinguishing material 111 from the internal cavity 119 into the chimney 117 when the temperature exceeds the normal operating temperature, indicating a fire within the chimney 117. The fire extinguishing material 111 acts to extinguish the fire within the chimney 117.

FIG. 2 illustrates the fire extinguishing material 111 being released and entering the chimney 117.

Chimney connecting device 121 connects the chimney 117 with the rain Dome 109 and may include a horizontal grid 101 (mesh screen) which may extend around the periphery of the chimney connecting device 121. The chimney connecting device 121 may have substantially the same cross-section as the chimney 117 (for example circular or rectangular) and may include an adjustable connecting band 107 which may adjust in dimension in order to detachably connect to the chimney 117 and may connect to a collar (not shown) to connect to a chimney 117 being a different size or shape. The chimney connecting device 121 includes the horizontal grid 101 to allow smoke and small particles to escape from the chimney 117.

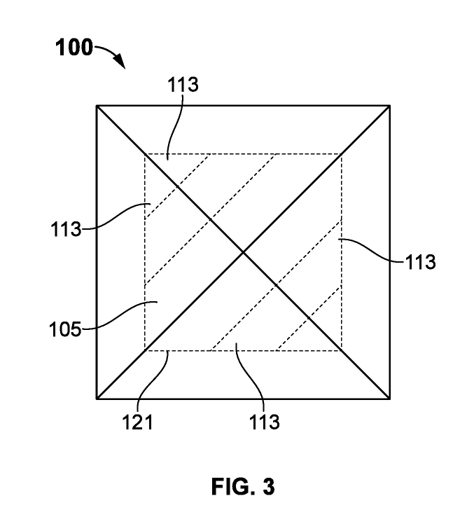

FIG. 3 illustrates a top view of the fire suppression system 100 and illustrates the top inclined walls 113 and the chimney connecting device 121 including the horizontal delivery door 105.

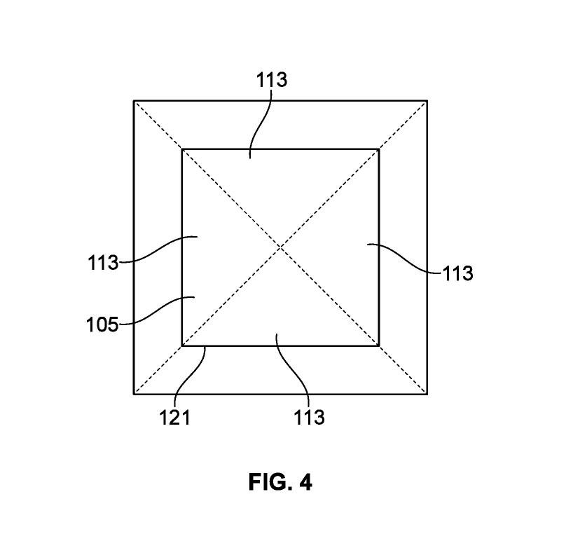

FIG. 4 illustrates a bottom view of the fire suppression system 100 and illustrates the top inclined walls 113 and the chimney connecting device 121 including the horizontal delivery door 105.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A fire suspension to suppress a chimney fire, comprising:
a chimney connecting device to connect to a chimney;
a rain dome to define an internal cavity;
wherein the internal cavity includes fire suppressing material;
wherein the rain dome includes a horizontal delivery door which is destructively opened in response to a chimney fire.

2) A fire suspension to suppress a chimney fire as in claim 1, wherein the fire suppressing material is B and C fire suppressing material.

3) A fire suspension to suppress a chimney fire as in claim 1, wherein the chimney connecting device includes an adjustable connecting band to connect to the chimney.

4) A fire suspension to suppress a chimney fire as in claim 1, wherein the chimney connecting device includes a horizontal grid to allow smoke and small particles to escape from the chimney.
